(19) United States
(12) Patent Application Publication
(10) Pub. No.: US 2018/0349094 A1
(43) Pub. Date: Dec. 6, 2018

(54) ELECTRONIC DEVICE, CONTROL METHOD, AND NON-TRANSITORY STORAGE MEDIUM

(71) Applicant: KYOCERA Corporation, Kyoto (JP)

(72) Inventors: Koutaro YAMAUCHI, Yokohama-shi (JP); Shigeki TANABE, Yokohama-shi (JP); Manabu SAKUMA, Yokohama-shi (JP); Isao MASUIKE, Tokyo (JP); Hideki MORITA, Yokohama-shi (JP); Yasuhiro UENO, Yokohama-shi (JP); Kenji SHIMADA, Yokohama-shi (JP)

(73) Assignee: KYOCERA Corporation, Kyoto (JP)

(21) Appl. No.: 15/989,694

(22) Filed: May 25, 2018

(30) Foreign Application Priority Data
May 30, 2017 (JP) 2017-106964

(51) Int. Cl. G06F 3/16; G10L 15/08; G10L 17/00; H04W 4/024; B61L 15/00; G06Q 10/10

(52) U.S. Cl. CPC G06F 3/167; G10L 15/08; G06Q 10/1093; H04W 4/024; B61L 15/0045; G10L 17/005

(57) ABSTRACT

An electronic device includes a voice input unit, a location sensor that acquires location information indicating a current location of the device itself, and a controller that can recognize voice input to the voice input unit. If the controller determines that a user is not carrying out a schedule as planned in schedule information of the user stored in advance based on the schedule information, and at least one of the location information and recognized predetermined voice other than voice of the user, the controller notifies the user of predetermined information.

### CROSS-REFERENCE TO RELATED APPLICATION(S)

The present application claims priority under 35 U.S.C. § 119 to Japanese Patent Application No. 2017-106964 filed in Japan on May 30, 2017, entitled “ELECTRONIC DEVICE, CONTROL METHOD, AND COMPUTER PROGRAM”. The content of which is incorporated by reference herein in its entirety.

### FIELD

Embodiments of the present disclosure relate to an electronic device.

### BACKGROUND

Electronic devices that acquire location information indicating their own current positions from a base station have conventionally been known. For example, a configuration in which an electronic device uses latitude/longitude information of a base station that is acquired from the base station as its own location information is known.

Electronic devices that perform voice recognition have conventionally been known also. For example, a configuration including a voice recognizing unit that recognizes input voice is known.

### SUMMARY

It is an object of the present disclosure to at least partially solve the problems in the conventional technology.

An electronic device according to one embodiment includes a voice input unit, a location sensor that acquires location information indicating a current location of the device itself, and a controller that can recognize voice input to the voice input unit. If the controller determines that a user is not carrying out a schedule as planned in schedule information of the user stored in advance based on the schedule information, and at least one of the location information and recognized predetermined voice other than voice of the user, the controller notifies the user of predetermined information.

A control method for an electronic device is disclosed. In one embodiment, the electronic device includes a voice input unit, a location sensor that acquires location information indicating a current location of the device itself, and a controller that can recognize voice input to the voice input unit. The method includes determining whether a user is carrying out a schedule as planned in schedule information of the user stored in advance based on the schedule information, and at least one of the location information and recognized predetermined voice other than voice of the user, and notifying the user of predetermined information if it is determined that the user is not carrying out the schedule as planned in the schedule information.

A non-transitory computer readable recording medium storing therein a control program for an electronic device that includes a voice input unit, a location sensor that acquires location information indicating a current location of the device itself, and a controller that can recognize voice input to the voice input unit is disclosed. In one embodiment, the control program makes the electronic device execute determining whether a user is carrying out a schedule as planned in schedule information of the user stored in advance based on the schedule information, and at least one of the location information and recognized predetermined voice other than voice of the user, and notifying the user of predetermined information if it is determined that the user is not carrying out the schedule as planned in the schedule information.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is an external view of an electronic device according to one embodiment;

FIG. 2 is a block diagram illustrating a functional configuration of the electronic device according to one embodiment;

FIGS. 3A and 3B are diagrams explaining examples of timing when schedule information of a user is recorded and an example of the schedule information of a user to be recorded;

FIG. 4 illustrates a route diagram of trains that a user takes;

FIGS. 5A and 5B are diagrams explaining about a first situation in which the electronic device according to one embodiment is used;

FIGS. 6A and 6B are diagrams explaining a second situation in which the electronic device according to one embodiment is used;

FIGS. 7A and 7B are diagrams explaining a third situation in which the electronic device according to one embodiment is used;

FIGS. 8A and 8B are images illustrating an example of action of the electronic device according to one embodiment;

FIG. 9 is a flowchart illustrating a first example of control that is performed by the electronic device according to one embodiment;

FIG. 10 is a flowchart illustrating a second example of control that is performed by the electronic device according to one embodiment;

FIG. 11 is a flowchart illustrating a third example of control that is performed by the electronic device according to one embodiment; and

FIG. 12 is a flowchart illustrating a fourth example of control that is performed by the electronic device according to one embodiment.

### DETAILED DESCRIPTION

Embodiments of the present disclosure are explained in detail referring to the drawings. The following embodiments are not intended to limit the present application. Components in the following explanation include what can be easily thought of by those skilled in the art and what are substantially identical, that is, what are within a range of so-called equivalents. As for explanation of the drawings, like reference symbols are assigned to like parts, and duplicated explanation can be omitted.

An electronic device 1 according to embodiments of the present application explained below can be, for example, a terminal such as so-called smartphone. However, the electronic device 1 according to embodiments of the present application is not limited to smartphone. The electronic device 1 can be, for example, a tablet, a personal computer, and the like.

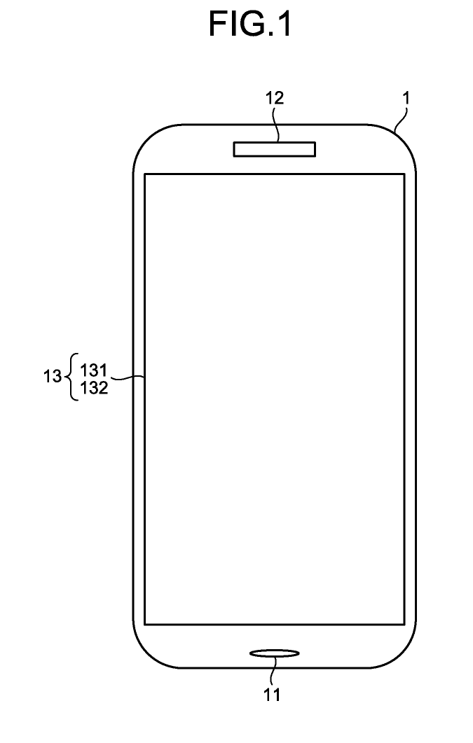

FIG. 1 is an external view of an electronic device 1 according to one embodiment. As illustrated in FIG. 1, the electronic device 1 includes a microphone 11 as a voice input unit, a speaker 12 as a voice output unit, and a touch panel 13.

The microphone 11 is one of an input means to accept an input to the electronic device 1. The microphone 11 collects ambient sounds.

The speaker 12 is one of an output means to perform output from the electronic device 1. The speaker 12 outputs voice of telephone, information about various kinds of programs, and the like in voice.

The touch panel 13 includes a touch sensor 131 and a display 132 as a display unit.

The touch sensor 131 is one of an input means to accept an input to the electronic device 1. The touch sensor 131 detects contact of a finger of a user, stylus, or the like. As a method of detecting contact, for example, a resistance film type and a capacitive type are available, but any type can be applied.

The display 132 is one of an output means to perform output from the electronic device 1. The display 132 displays objects, such as characters, images, symbols, and figures, on a screen. For the display 132, for example, a liquid crystal display or an organic electroluminescence (EL) display is used.

In the touch panel 13 illustrated in FIG. 1, the display 132 is arranged to overlap the touch sensor 131, and a display region of the display 132 overlaps the touch sensor 131, but the embodiments are not limited thereto. The display 132 and the touch sensor 131 can be arranged, for example, side by side or in a separated manner. When the display 132 and the touch sensor 131 overlap each other, one or more sides of the display 132 do not necessarily need to match with any side of the touch sensor 131.

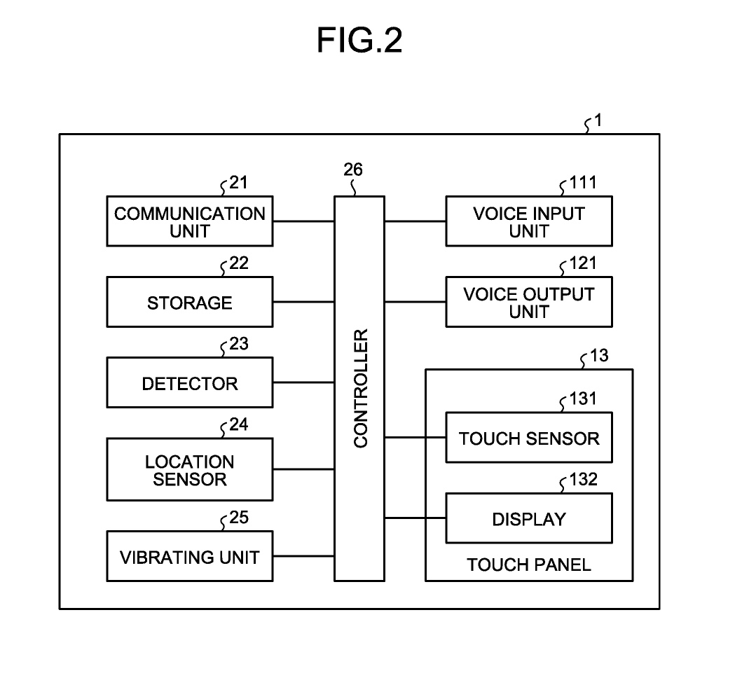

A functional configuration of the electronic device 1 is explained referring to FIG. 2. FIG. 2 is a block diagram illustrating the functional configuration of an electronic device 1 according to one embodiment. As illustrated in FIG. 2, the electronic device 1 includes a voice input unit 111, a voice output unit 121, the touch sensor 131, the display 132, a communication unit 21, a storage 22, a detector 23, a location sensor 24, a vibrating unit 25, and a controller 26.

The voice input unit 111 inputs a signal corresponding to input voice to the controller 26. The voice input unit 111 includes the microphone 11 described above. The voice input unit 111 can be an input interface to which an external microphone can be connected. The external microphone is connected wirelessly or with a cable. The microphone to be connected to the input interface is, for example a microphone equipped in an earphone connectable to electronic devices, or the like.

The voice output unit 121 outputs voice based on a signal input from the controller 26. The voice output unit 121 includes the speaker 12 described above. The voice output unit 121 can be an output interface to which an external speaker can be connected. The external speaker is connected wirelessly or with a cable. The speaker to be connected to the output interface is, for example a speaker equipped in an earphone connectable to electronic devices, or the like.

The touch sensor 131 detects a contact operation by a finger or the like and inputs a signal corresponding to the detected contact operation to the controller 26.

The display 132 displays objects, such as characters, images, symbols, and figures, on a screen based on the signal input from the controller 26.

The communication unit 21 performs communication wirelessly. Examples of the wireless communication standard supported by the communication unit 21 include, but are not limited to, cellular phone communication standards, such as 2G, 3G, and 4G, and near-field communication standards. The cellular phone communication standards include, for example, Long Term Evolution (LTE), Wideband Code Division Multiple Access (W-CDMA), Worldwide Interoperability for Microwave Access (WiMAX), CDMA2000, Personal Digital Cellular (PDC), Global System for Mobile Communications (GSM) (registered trademark), and Personal Handy-phone System (PHS). Examples of the near-field communication standard include, but are not limited to, IEEE802.11, Bluetooth (registered trademark), Infrared Data Association (IrDA), Near Field Communication (NFC), and Wireless Personal Area Network (WPAN). The WPAN communication standard includes, for example, ZigBee (registered trademark). When performing wireless communication by a cellular phone communication standard, the communication unit 21 establishes a wireless network through a channel assigned by a base station, and performs telephone communication and data communication with the base station. By connecting to a Wi-Fi (registered trademark) compliant access point (AP), the communication unit 21 can perform data communication through AP also.

The storage 22 stores programs and data. The storage 22 is also used as work area to store a processing result of the controller 26 temporarily. The storage 22 can include any type of non-transitory storage medium, such as a semiconductor storage medium and a magnetic storage medium. The storage 22 can include more than one type of storage medium. The storage 22 can include also a combination of a portable storage medium, such as a memory card, an optical disk, and a magneto-optical disk, and a reader of the storage medium. Furthermore, the storage 22 can include a storage device that is used as a general storage area, such as a random-access memory (RAM). The programs stored in the storage 22 include an application that is executed foreground or background, and a control program that supports operation of the application.

The storage 22 stores schedule information of a user (hereinafter, simply “schedule information” also) as text data. The schedule information can be predetermined text data itself that is held as data by various kinds of applications. Alternatively, the schedule information can be stored in another area in the storage 22 based on text data held by various kinds of applications. In this case, the schedule information can be automatically stored without operation by a user, or can be stored based on operation determining whether to store as schedule information by the user. Examples of the schedule information of a user include, but are not limited to, transfer guide information relating to train transfers or the like set by a train-route search application (application is hereinafter also referred to as “app”), and navigation information relating to travel by foot, train, bus, or the like set by a map application. Specifically, the transfer guide information includes planned get-off stations such as a transfer station at which a user gets off a train when transferring to a train of another line, and a destination station at which the user gets off a train when finishing travel by train to go to a final destination, a line name of a line taken by the user, and the like, but not limited thereto. For example, the transfer guide information can include information about scheduled arrival times of stations present between a starting station and a destination station set by the user, location information of stations at which the train stops, information about a route from the starting station to the destination station, and the like. Similarly, for example, the navigation information can include information about stations at which a train taken by a user stops, a line name, a bus stop at which the user gets on a bus, a line name and a route name of the bus, and scheduled arrival times of stations of a train or bus stops of a bus present between a starting point and a destination point set by the user, location information of stations and bus stops, route information from the starting point to the destination point, and the like.

The storage 22 stores voice-recognition dictionary data and recognition-target voice data. The voice-recognition dictionary data is data in which characteristic patterns of voice (characteristic amount) and character strings are associated with each other. The recognition-target voice data is data in which information about volume, pitch, tone, frequency, and the like and various kinds of voices to be a target of voice recognition are associated with each other.

The detector 23 detects a state of the electronic device 1, and inputs the detected result to the controller 26. The detector 23 includes at least an acceleration sensor. The detector 23 can further include a gyro sensor, an azimuth sensor, and the like. The acceleration sensor detects a direction and a magnitude of acceleration acting on the electronic device 1. The gyro sensor detects an angle and an angular velocity of the electronic device 1. The azimuth sensor detects a direction of the magnetism of the earth.

The location sensor 24 acquires location information indicating its own current position, and inputs the acquired result to the controller 26. The location sensor 24 detects its own position, for example, based on a base station with which a global positioning system (GPS) receiver or the communication unit 21 establishes a wireless network.

The vibrating unit 25 operates based on a signal input from the controller 26. The vibrating unit 25 is, for example, a vibrating motor such as an eccentric motor, but not limited thereto. When the vibrating unit 25 operates, the entire electronic device 1 vibrates.

The controller 26 controls overall operation of the electronic device 1. The controller 26 is an arithmetic processing device. Examples of the arithmetic processing device include, but not limited to, a central processing unit (CPU), a system-on-a-chip (SoC), a micro control unit (MCU), a field-programmable gate array (FPGA), and a coprocessor.

The controller 26 performs various kinds of controls, such as carrying out of a function of the electronic device 1 and change of settings, based on a signal that is input according to a contact operation detected by the touch sensor 131, or the like.

The controller 26 detects changes in acceleration and inclination of the electronic device 1 based on a detection result of the detector 23. By detecting changes in acceleration and inclination of the electronic device 1, the controller 26 detects changes of state of the electronic device 1 from a state of not being held in a hand of a user to a state of being held in a hand of a user, and from a state of being held in a hand of a user to a state of not being held in a hand of a user. The controller 26 also detects changes of state of a user from a state of not traveling to a state of traveling, and from a state of traveling to a state of not traveling. The controller 26 further detects changes of state of a user from a state of not being on a means of transport to a state of being on a predetermined means of transport, and from a state of a user being on a means of transport to a state of not being on a predetermined means of transport.

The controller 26 recognizes the location information indicating its own (user's) current position based on the location information acquired by the location sensor 24.

The controller 26 recognizes voice (voice recognition) by analyzing voice input to the voice input unit 111. The controller 26 reads out a character string from the voice-recognition dictionary data that is stored in the storage 22 based on a characteristic pattern of the input voice as voice recognition processing. When reading out a character string, the controller 26 compares the voice-recognition dictionary data and a characteristic pattern of input voice, and determines the similarity therebetween.

The controller 26 identifies a source of voice by analyzing the voice input to the voice input unit 111. As voice recognition processing, the controller 26 compares the recognition-target voice data that is stored in the storage 22 and volume, pitch, tone, frequency, and the like of input voice, and determines the similarity. Thus, the controller 26 can identify the source of the input voice. That is, in addition to voice of a user, the controller 26 can recognize voice other than voice of a user, including voice of announcement and environmental sound generated from a means of transport, such as trains.

The controller 26 determines that a user is not carrying out a schedule as planned in schedule information of the user based on the schedule information of the user and at least one of the location information acquired by the location sensor 24 and the recognized predetermined voice other than voice of the user. If determining that a user is not carrying out a schedule as planned in the schedule information of the user, the controller 26 notifies the user of predetermined information.

The controller 26 can determine that a user is carrying out a schedule as planned in first schedule information based on the first schedule information and at least one of the location information acquired by the location sensor 24 and recognized first predetermined voice other than voice of the user. In this case, if determining that a user is not carrying out a schedule as planned in second schedule information based on second schedule information and at least one of second location information that is acquired by the location sensor 24 and recognized second predetermined voice other than voice of the user after determining that the user is carrying out a schedule as planned in the first schedule information, the controller 26 notifies the user of predetermined information. On the other hand, even if determining that the user is not carrying out a schedule as planned in the second schedule information based on the second schedule information and at least one of the second location information acquired by the location sensor 24 and the recognized second predetermined voice other than voice of the user, the controller 26 does not notify the user of the predetermined information if it has not been determined that the user is carrying out a schedule as planned in the first schedule information.

Carrying out a schedule by a user as planned in schedule information of the user can be regarded as arrival at a planned get-off station of a train that the user is on. Not carrying out a schedule as planned in schedule information of the user can be regarded as failure to get off a train that the user is on. That is, the controller 26 can determine that the user has arrived at a planned get-off station of a train that the user is on based on the first schedule information and at least one of the first location information acquired by the location sensor 24 and the recognized first predetermined voice other than voice of the user. In this case, if determining that the user has failed to get off the train that the use is on based on the second schedule information and at least one of the second location information acquired by the location sensor 24 and the recognized second predetermined voice other than voice of the user after determining that the user has arrived at the planned get-off station of the train that the user is on, the controller 26 notifies the user of predetermined information. On the other hand, even if determining that the user has failed to get off the train that the user is on based on the second schedule information and at least one of the second location information and the second predetermined voice, the controller 26 does not notify the user of the predetermined information if it has not been determined that the user has arrived at the planned get-off station of the train that the user is on.

Carrying out a schedule as planned in schedule information of the user and not carrying out a schedule as planned in schedule information of the user are not limited to be regarded as arrival of at a planned get-off station of a train that the user is on and failure to get off a train that the user is on. Examples of carrying out a schedule as planned in schedule information of the user include, but are not limited to, the user taking a train line that the user is supposed to take, the user being positioned between a starting station and a transfer station, and the user arriving at a planned get-off stop of a bus that the user is supposed to take. Examples of failure of carrying out a schedule as planned in schedule information of the user include, but are not limited to, the user getting off a train at a station prior to a transfer station by mistake, and the user failing to get off a bus that the user is on.

The controller 26 can determine that a train that the user is on has arrived at a planned get-off station based on the first schedule information and the recognized first predetermined voice, and can determine that the user has failed to get off the train based on the second schedule information and the recognized second predetermined voice. The first predetermined voice can include a name of a station at which the user is supposed to get off the train. The second predetermined voice does not need to include the name of the station at which the user is supposed to get off the train. In this case, the second predetermined voice can include a name of a station that is present on a train route taken by the user and ahead of the station at which the user is supposed to get off the train in a traveling direction of the train that the user is on. The first schedule information and the second schedule information can be the same data.

Specifically, first, when the controller 26 recognizes voice, the controller 26 determines whether the voice is predetermined voice other than voice of the user (hereinafter, also “predetermined voice” simply). The predetermined voice other than voice of the user is, for example, announcement in a train or at a platform of a station. The predetermined voice other than voice of the user is, in other words, spoken voice output from an electronic device based on a predetermined voice signal. When the recognized voice is predetermined voice other than voice of the user, the controller 26 performs processing based on the schedule information of the user and information included in the predetermined voice. When the recognized voice is voice of the user, the controller 26 does not need to perform any processing. The information included in the predetermined voice is a character string that is read from the voice-recognition dictionary data described above when the controller 26 recognizes the predetermined voice. When a certain condition is satisfied after recognition of the predetermined voice, the controller 26 performs predetermined processing. The controller 26 can notify the user of predetermined information as the predetermined processing.

If the recognized first predetermined voice includes a name of a station at which the user is supposed to get off, the controller 26 can determine matching between the first schedule information and the first predetermined voice, to judge that the train that the user is on has arrived at the planned get-off station. If the recognized second predetermined voice does not include a name of a station at which the user is supposed to get off the train, but particularly includes a name of a station that is present on a train route taken by the user and ahead of the planned get-off station for the user in a traveling direction of the train that the user is on, the controller 26 can determine not-matching between the second schedule information and the second predetermined voice, to judge that the user has failed to get off the train. If the controller 26 judges that the user has failed to get off the train, the controller notifies the user of predetermined information.

The controller 26 can determine that the train that the user is on has arrived at a planned get-off station based on the first schedule information and the first location information that is acquired by the location sensor 24, and can determine that the user has failed to get off the train based on the second schedule information and the second location information that is acquired by the location sensor 24. In this case, the first schedule information can include location information corresponding to a name of a station at which the user is supposed to get off the train. The second schedule information can include route information from a starting station to a destination station for the user. Transfer stations between the starting station and the destination station can be included therein. In this case, the route information is created based on location information of stations of plural lines.

Specifically, the controller 26 can determine that the train that the use is on has arrived at the planned get-off station if the controller 26 recognizes its own entrance to a predetermined range around location information corresponding to the name of the station at which the user is supposed to get off the train from the outside of the range based on the first location information. On the other hand, the controller 26 can determine that the user has failed to get off the train if the controller 26 recognizes its own movement toward a direction departing from the route information corresponding to the line of the train that the user is on based on the second location information. If the controller 26 determines that the user has failed to get off the train, the controller notifies the user of predetermined information. The direction departing from the route information corresponding to the line of the train that the user is on can be a traveling direction of the train that the user is on also.

The schedule information of a user can include, as described above, arrival time information of a station at which a train that the user is on stops. When the schedule information of the user includes the arrival time information of the station at which the train that the user is on stops, the controller 26 can determine that the user has failed to get off the train based on the schedule information of the user, a current time, and at least one of the location information that is acquired by the location sensor 24 and the recognized predetermined voice other than voice of the user, and can notify the user of predetermined information.

In addition, the controller 26 can detect its own state of not being held in a hand of a user and a state in which the user is not traveling based on a detection result by the detector 23 as described above. When the controller 26 detects its own state of not being held in a hand of a user based on a detection result by the detector 23, the controller 26 can determine that the user has failed to get off the train based on a result of determination that it is not held in a hand of the user, in addition to the schedule information of the user, and at least one of the location information that is acquired by the location sensor 24 and the recognized predetermined voice other than voice of the user, and can notify the user of predetermined information. When the controller 26 detects the state of the user in which the user is not traveling based on a detection result by the detector 23, the controller 26 can determine that the user has failed to get off the train based on a determination result that the user is not traveling in addition to the schedule information of the user, and at least one of the location information that is acquired by the location sensor 24 and the recognized predetermined voice other than voice of the user, and can notify the user of predetermined information.

The controller 26 can accept an input of voice all the time, without setting a start timing and a stop timing of voice input acceptance. In this case, when the controller 26 identifies that a user is on a predetermined means of transport based on recognized environmental sound, the controller 26 can recognize predetermined voice other than voice of the user included in the entire input voice.

The controller 26 can be arranged to accept an input of voice only when the controller 26 determines that a user is on a predetermined means of transport based on a detection result by the detector 23.

The controller 26 can be configured to accept an input of voice only if the controller 26 determines that a user is located in a predetermined range around a predetermined location based on the location information that is acquired by the location sensor 24. The predetermined location is, for example, location information of a get-off station (for example, transfer station, destination station) of a train that a user takes.

The controller 26 can be arranged to accept an input of voice only when a predetermined application is operating. The application can be operating either foreground or background.

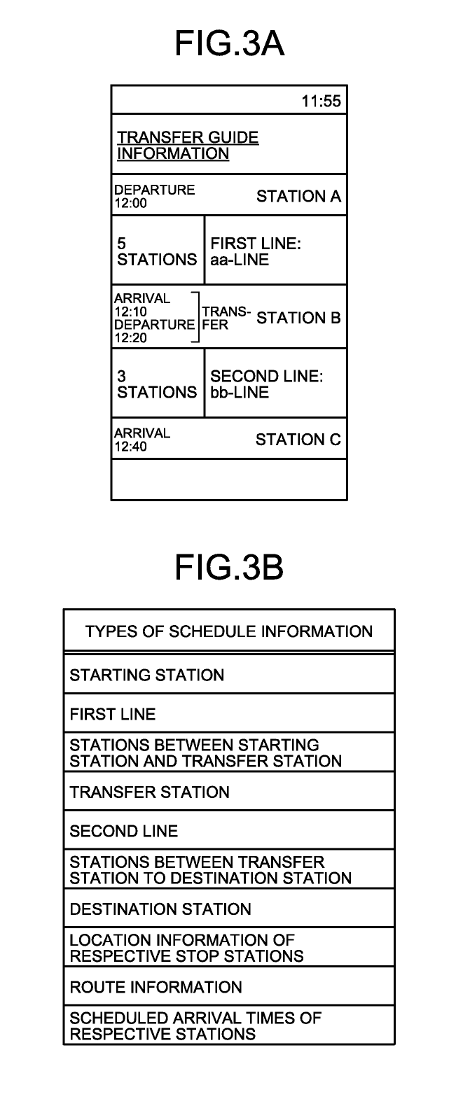

Timing when the schedule information of a user is stored in the electronic device 1 and an example of user information to be stored are explained referring to FIGS. 3A and 3B.

FIG. 3A illustrates transfer guide information that is provided in a route guide app. The transfer guide information is displayed on the display 132 based on data, such as a starting station, a destination station, and a departure possible time of a user that are input by the user. Specifically, on the display 132, information such as station A as the starting station, station B as the transfer station, station C as the destination, aa-line and bb-line as train routes that the user takes, a departure time of aa-line at station A and an arrival time of aa-line at station B, and a departure time of bb-line at station B and an arrival time of bb-line at station C, five stations as the number of stations that are present between station A and station B, and three station as the number of stations that are present between station B and station C is displayed as transfer guide information. At this time, the schedule information of a user is stored in the storage 22. The schedule information of a user can be predetermined data in entire data to display this transfer guide information. The schedule information of a user can also be predetermined data that is extracted from the entire data to display the transfer guide information. When predetermined data is extracted from the entire data to display the transfer guide information, the extracted predetermined data can be stored in a place in the storage 22 where it is different from a place to store data to display the transfer guide information as described above.

FIG. 3B illustrates an example of the schedule information of a user. The schedule information of a user can be one illustrated in FIG. 3B, but is not limited thereto, and can be various kinds of data that are included in the transfer guide information. The schedule information of a user illustrated in FIG. 3B includes information that is not illustrated in FIG. 3A, such as stations between the starting station and the transfer station, and location information of each stopping station. The schedule information of a user in FIG. 3B that is not illustrated in FIG. 3A is just not displayed on a screen illustrated in FIG. 3A, but can be included in the transfer guide information from the beginning. Furthermore, the schedule information of a user in FIG. 3B that is not illustrated in FIG. 3A can be information that is acquired by the controller 26 by accessing information on the Internet based on information included in the transfer guide information, or can be information that is acquired by referring to predetermined information other than the transfer guide information held in the storage 22. Specifically, for example, when a name of a station is identified as the transfer guide information, location information corresponding to the station can be acquired by searching on the Internet, and the name of the station and the corresponding location information can be used as the schedule information of a user. The route information is information in which predetermined pieces of location information are displayed successively in a straight line or a curved line. In the following, explanation is given, supposing that the information illustrated in FIG. 3B is stored in the electronic device 1 as the schedule information of a user.

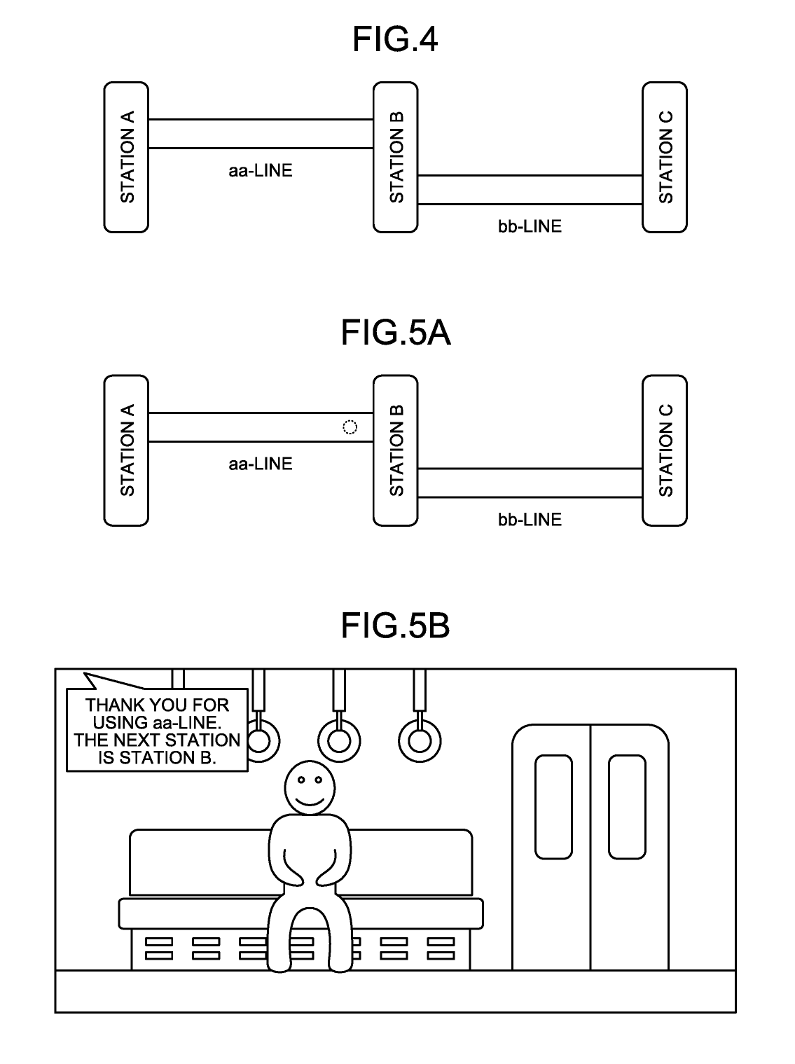

A train that is taken by a user is explained referring to FIG. 4. FIG. 4 illustrates a route diagram including a transfer station when the starting station is station A and the destination station is station C. FIG. 4 only illustrates a route relating to stations that appear during the user is on the train for simplicity. Moreover, names of stations that are present between the starting station, station A and the transfer station, station B, and names of stations that are present between the transfer station, station B and the destination station, station C are omitted.

A first situation in which the electronic device 1 according to the present disclosure is used is explained referring to FIGS. 5A and 5B. In FIGS. 5A and 5B, the user is on a train carrying the electronic device 1 in which the schedule information of the user described above is stored.

FIG. 5A indicates a position of the user on the route illustrated in FIG. 4. Specifically, the device itself (user) is positioned at a position a little short of station B on aa-line, expressed by a circle in a dotted line on the route diagram. At this time, the controller 26 can recognizes matching between the location information that is acquired by the location sensor 24 and location information of station B that corresponds to the first schedule information, to judge that the user has arrived at the transfer station (planned get-off station) of the train that is the user is on. The controller 26 can determine its own entrance to a predetermined range around the location information of station B as the center from outside of the predetermined range, to judge that the user has arrived at the transfer station (planned get-off station) of the train that the user is on based on the acquired location information.

FIG. 5B illustrates a situation in which a train announcement is made while the user is on a train. The announcement says, “Thank you for using aa-line. The next station is station B”. The announcement is made predetermined time before the train stops at station B. Generally, the announcement is made a few minutes before a stop. The controller 26 can first recognize voice of announcement that is input to the voice input unit 111. Subsequently, the controller 26 can recognize matching between information, “aa-line” and “station B” included in the voice of the recognized announcement and a first line name and a transfer station corresponding to the first schedule information, to judge that the user has arrived at the transfer station (planned get-off station) of the train that the user is on. The controller 26 can determine arrival at a get-off station of a train that the user is on only when the voice of the recognized announcement and more than one piece of the first schedule information match each other.

The processing of determining matching of information by the controller 26 is not limited to be performed for complete matching of character strings. That is, the processing of determining matching of information can be processing of determining similarity of information. For example, suppose that when the schedule information of the user includes text information of “station B” and “transfer station”, and these pieces of information are stored in an associated manner or the like, thereby storing information indicating that station B is a transfer station in the storage 22 as the user information. In this case, when a character string that is recognized from predetermined voice is “the train will arrive shortly at station B”, the controller 26 can determine that the information of the predetermined voice and the schedule information of the user match each other. The controller 26 can compare respective pieces of character information (sentences), and determine whether to be similar by a method of calculating the number of common characters, the number of common characters adjacent to a specific character, or the like.

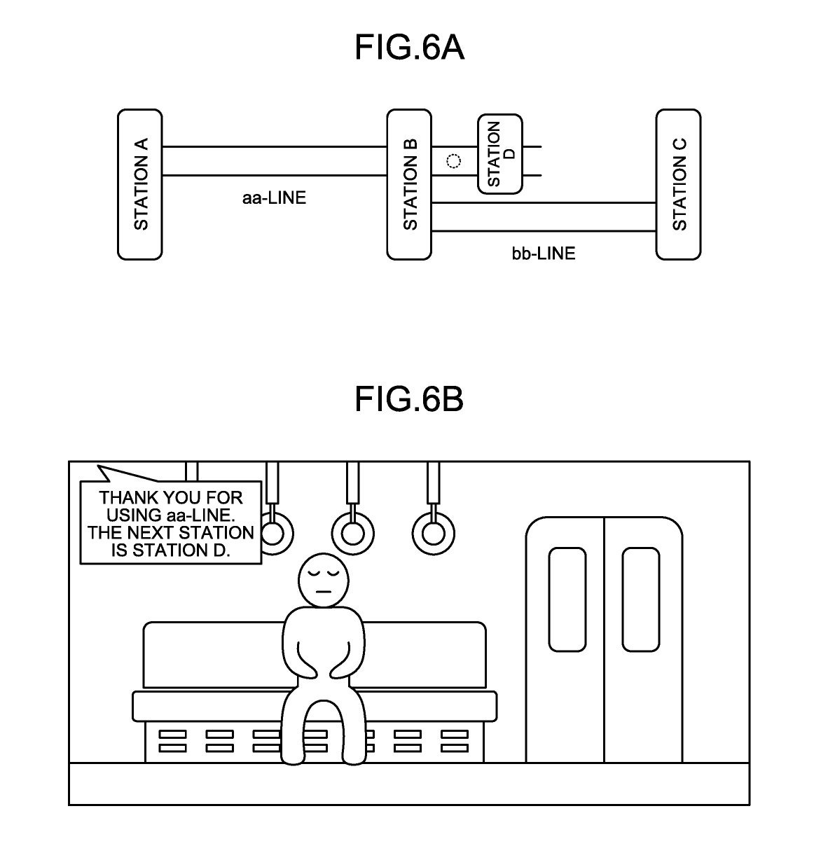

A second situation in which the electronic device 1 according to the present disclosure is used is explained referring to FIGS. 6A and 6B. In FIGS. 6A and 6B, the user is on a train carrying the electronic device 1 in which the schedule information of the user described above is stored.

FIG. 6A indicates a position of the user on the route illustrated in FIG. 4. Specifically, the user is positioned at a position a little past station B and short of station D on aa-line, expressed by a circle in a dotted line on the route diagram. At this time, the controller 26 can judge that the user has failed to get off the train based on the location information acquired by the location sensor 24 and route information from the starting station to the destination station of the user corresponding to the second schedule information. That is, if the controller 26 recognizes its own travel in a direction departing from the route information, the controller 26 can judge that the user has failed to get off the train.

FIG. 6B illustrates a situation in which a train announcement is made while the user is on a train. The announcement says, “Thank you for using aa-line. The next station is station D”. The announcement is made predetermined time before the train stops at station D. Generally, the announcement is made a few minutes before a stop. The controller 26 recognizes voice of announcement that is input to the voice input unit 111. Subsequently, the controller 26 recognizes not-matching between information, “station D” included in the voice of the recognized announcement and the second schedule information, to judge that the user has failed to get off the train. In other words, when the controller 26 recognizes a name of a station that is present ahead of a transfer station (planned get-off station) in a traveling direction of the train that the user is on included in the voice of the recognized announcement, the controller 26 judges that the user has failed to get off the train. In this case, the second schedule information can be schedule information of the user other than the first schedule information. The controller 26 can judge that the user has failed to get off the train only if the controller 26 recognizes both matching between predetermined voice and the first schedule information and not-matching between predetermined voice and the second schedule information. Specifically, the controller 26 can judge that the user has failed to get off the train only if the controller 26 recognizes matching between the information, “aa-line” included in the voice of the recognized announcement and the first schedule information (first line name), and recognizes not-matching between the information, “station D” included in the voice of the recognized announcement and the second schedule information that is schedule information of the user other than the first line name. By thus configuring, the electronic device 1 is enabled to determine that it has passed a planned get-off station, having determined that it is taking aa-line. The storage 22 can store stop station information about a part of or all of stations of aa-line at which the train stops including the information, “station D” in advance. The stop station information can be stored in the storage 22 after the schedule information of the user is stored in the storage 22. Alternatively, the stop station information can be acquired by the electronic device 1 by accessing information that is present on a network on the Internet after the schedule information of the user is stored in the storage 22.

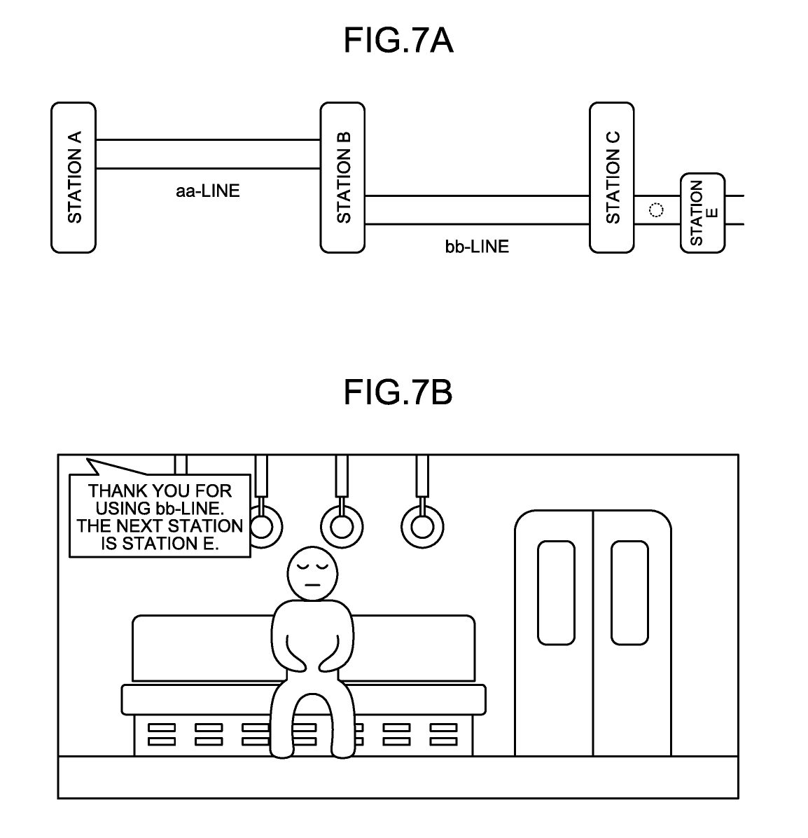

A third situation in which the electronic device 1 according to the present disclosure is used is explained referring to FIGS. 7A and 7B. In FIGS. 7A and 7B, the user is on a train carrying the electronic device 1 in which the schedule information of the user described above is stored. FIG. 7A indicates a position of the user on the route illustrated in FIG. 4. Specifically, the user is positioned at a position past station C and short of station E on bb-line, expressed by a circle in a dotted line on the route diagram. At this time, the controller 26 can judge that the user has failed to get off the train based on the location information acquired by the location sensor 24 and route information from the starting station to the destination station of the user corresponding to the second schedule information. That is, if the controller 26 recognizes its own travel in a direction departing from the route information, the controller 26 can judge that the user has failed to get off the train.

FIG. 7B illustrates a situation in which a train announcement is made while the user is on a train. The announcement says, “Thank you for using bb-line. The next station is station E”. The announcement is made predetermined time before the train stops at station E. Generally, the announcement is made a few minutes before a stop. The controller 26 recognizes voice of announcement that is input to the voice input unit 111. Subsequently, the controller 26 recognizes not-matching between information, “station E” included in the voice of the recognized announcement and the second schedule information, to judge that the user has failed to get off the train. In other words, when the controller 26 recognizes a name of a station that is present ahead of a transfer station (planned get-off station) in a traveling direction of the train that the user is on included in the voice of the recognized announcement, the controller 26 judges that the user has failed to get off the train. The storage 22 can store stop station information about a part of or all of stations of bb-line at which the train stops including the information, “station E” in advance. The stop station information can be stored in the storage 22 after the schedule information of the user is stored in the storage 22. Alternatively, the stop station information can be acquired by the electronic device 1 by accessing information that is present on a network on the Internet after the schedule information of the user is stored in the storage 22.

As described above, the controller 26 determines that the user has failed to get off a train that the user is on, that is, that the user is not carrying out a schedule as planned in the schedule information of the user, based on the schedule information of the user and at least one of location information acquired by the location sensor 24 and recognized predetermined voice other than voice of the user. If the controller 26 determines that the user is not carrying out the schedule as planned in the schedule information of the user, the controller 26 notifies the user of predetermined information. The electronic device 1 thus configured can support the user if the user fails to carry out a schedule as planned in the schedule information of the user. Specifically, the user can be aware of failure to get off a train promptly.

As indicated in the example of the user information in FIG. 3B, the user information can include information about scheduled arrival times of respective stations. In this case, the controller 26 can determine whether arrival time information of a transfer station of the user and a current time match each other, or whether a time difference between the arrival time information of the transfer station and the current time is smaller than predetermined time, to judge whether the user has failed to get off the train including a result of the determination. For example, if the conditions for judging that a user has failed to get off a train described in FIGS. 6A to 7B are satisfied even though the current time matches the scheduled arrival time of the transfer station of the user, the controller 26 can judge that the user has failed to get off the train. Thus, the electronic device 1 can accurately determine whether a user is carrying out a schedule as planned in the schedule information of the user, that is, whether the user has failed to get off a train, resulting in improving the reliability of information to be notified.

As described above, the controller 26 can determine that the device itself is not held in a hand of a user based on a detection result by the detector 23. In this case, the controller 26 can judge that the user has failed to get off the train based on the schedule information of the user; at least one of the location information that is acquired by the location sensor 24 and the recognized predetermined voice other than voice of the user; and a determination result that the device itself is not held in a hand of the user. If the controller 26 determines that the user has failed to get off the train, the controller 26 can notify the user of predetermined information. The controller 26 can detect that the user is in a state of not traveling based on a detection result by the detector 23. In this case, the controller 26 can judge that the user has failed to get off the train that the user is on based on the schedule information of the user; at least one of the location information that is acquired by the location sensor 24 and recognized predetermined voice other than voice of the user; and a determination result that the user is not traveling. If the controller 26 determines that the user has failed get off the train that the user is on, the controller 26 can notify the user of predetermined information. Thus, the electronic device 1 can accurately determine whether a user is carrying out a schedule as planned in the schedule information of the user, that is, whether the user has failed to get off a train, resulting in improving the reliability of information to be notified.

The processing and operation of the electronic device 1 explained in FIGS. 6A to 7B can be performed only after the processing of the electronic device 1 illustrated in FIGS. 5A and 5B is performed. In other words, if the controller 26 judges that the user is not carrying out a schedule as planned in the second schedule information based on the second schedule information, and at least one of the second location information that is acquired by the location sensor 24 and the recognized second predetermined voice other than voice of the user after determining that the user is carrying out a schedule as planned in the first schedule information, the controller 26 can notify the user of predetermined information. The the controller 26 does not need to notify the user of the predetermined information even if the controller 26 judges that the user is not carrying out a schedule as planned in the second schedule information based on the second schedule information, and at least one of the second location information that is acquired by the location sensor 24 and the recognized second predetermined voice other than voice of the user if not having judged that the user is carrying out a scheduled as planned in the first schedule information. The electronic device 1 thus configured can accurately determine that a user has turned into a state of not being able to carry out a schedule as planned in the schedule information of the user from a state of carrying out the schedule as planned, resulting in improving the reliability of information to be notified.

The controller 26 can use location information that is acquired by the location sensor and recognized predetermined voice in combination if determining whether a user is carrying out a schedule as planned in the schedule information of the user.

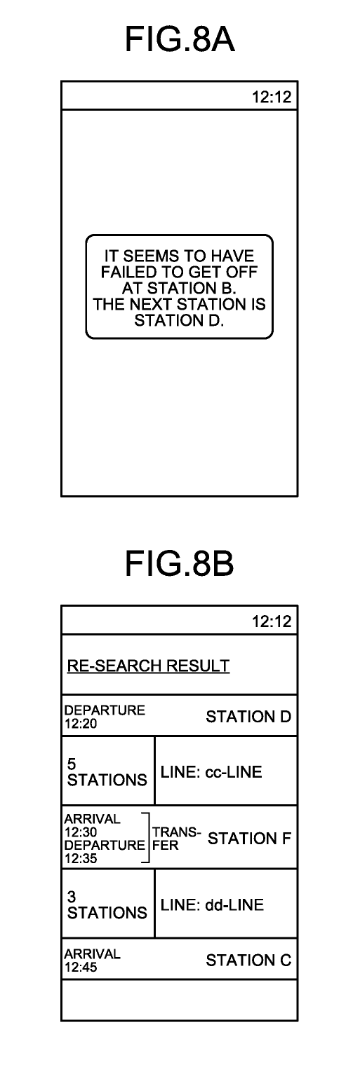

An example of operation of the electronic device 1 if the controller 26 judges that a user has failed to get off a train is explained referring to FIGS. 8A and 8B. If the controller 26 judges that a user has failed to get off a train, the controller 26 notifies the user of predetermined information. FIGS. 8A and 8B are images illustrating an example of information that is displayed on the display 132 of the electronic device 1 as one of the predetermined information. The operation of the electronic device 1 in FIGS. 8A and 8B corresponds to the situation explained in FIGS. 6A and 6B. That is, if the controller 26 judges that a user has failed to get off a train, the controller 26 displays the predetermined information on the display 132 of the electronic device 1 to notify of it to the user.

As illustrated in FIG. 8A, for example, characters, “It seems to have failed to get off the train at station B. The next station is station D” are displayed on the display 132. By this notification, the user can be aware of the fact that he/she has failed to get off the train promptly.

As illustrated in FIG. 8B, for example, a result of re-search for the destination station, that is, transfer guide information from station D, which is the next stop station, to station C is displayed on the display 132. The controller 26 can acquire the re-search result based on the schedule information of the user and location information indicating its own current position that is acquired by the location sensor 24, to display on the display 132. The controller 26 can acquire the re-search result based on the schedule information of the user and recognized predetermined voice, that is, announcement saying “Thank you for using aa-line. The next station is station D”, to display on the display 132. By this notification, the user can promptly recover from a mistake that he/she has deviated from the schedule of the user, that is, failure to get off the train. The re-search result is preferable to be notified as illustrated in FIG. 8B if a user has failed to get off at a transfer station. If a user has failed to get off a train at a transfer station, there is a case that the user can get to the destination station earlier by using another line than by taking a train running in the opposite direction on the same line as the train the user has been taking.

The controller 26 can notify the user of the predetermined information by a predetermined application. For example, the controller 26 can perform notification by a route guide app that is a source of information in which the schedule information of the user is stored, or can perform the notification by a predetermined app other than the route guide app.

The controller 26 can display an indication to have the user choose whether to display a re-search result on the display 132 before displaying the re-search result. In this case, when the user chooses to display the re-search result by a predetermined operation such as an operation of a touch panel, the re-search result illustrated in FIG. 8B is displayed on the display 132.

Alternatively, the controller 26 can perform notification to the user by vibrating the vibrating unit 25.

The controller 26 can perform notification to the user by causing the voice output unit 121 to output voice. The output voice can be a notification sound, a beep sound that is easy for the user to awake, or the like. Information that is included in the output voice can be information identical or similar to the information displayed on the display 132 illustrated in FIGS. 8A and 8B.

The various kinds of notification methods such as notification by displaying information on the display 132, notification by vibration, and notification by sound output described above, can be combined to be performed.

The voice input unit 111 can be an input interface to which an external microphone can be connected as described above. When the voice input unit 111 is an input interface to which an external microphone can be connected, and an external microphone is connected to the input interface, input of voice can be performed by the external microphone. Thus, the electronic device 1 can reduce interruption of voice due to clothes or the like that can be caused when a user carries the electronic device 1 in a pocket or the like, thereby reducing a possibility that voice cannot be recognized. The input interface to which an external microphone can be connected is, for example, a microphone equipped in an earphone.

As described above, the voice output unit 121 can be an input interface to which an external speaker can be connected as described above. When the voice output unit 121 is the input interface to which an external speaker can be connected, and the external speaker is connected to the input interface, notification of information by voice output is performed by the external speaker. When an external speaker is connected, notification of information can be performed only by the external speaker, or by the external speaker and the display 132. Thus, the user can acquire the information without looking at the display 132. With this configuration, when an external speaker is not connected, the controller 26 can perform notification by the display 132 or the vibrating unit 25 without performing notification by the voice output unit 121. The input interface to which an external speaker can be connected is, for example, a speaker of an earphone that is connected to the electronic device 1, and in this case, the user can acquire information in voice without leaking voice to people around.

When a predetermined operation to the device has not been performed for predetermined time since predetermined information is output, the controller 26 can output the information again. At this time, the information to be output can be voice or vibration. Examples of the predetermined operation include, but are not limited to, confirmation of contents of the information by touching an object indicating presence of the notified information, and touch of a predetermined object that is provided on a screen on which the notified information is displayed on the display 132. The object indicating presence of the notified information is displayed in a notification area or on a lock screen. The notification area is, for example, provided at an upper part of a screen of the display 132, and displays information corresponding to events, such as reception of a mail and a missed call, by using objects, such as characters and icons. The information displayed in the notification area can be displayed also on a lock screen for example, that is displayed first after recovering the display 132 from a sleep state. Thus, the electronic device 1 notifies of presence of information that has been output to the user again when there is a high possibility that the notified information has not been received by the user, thereby reducing a possibility that the user misses to know the information that has been notified.

When it is determined that the user has not started moving within predetermined time, that is, that the user has not moved for predetermined time since the information is given based on a detection result by the detector 23, the controller 26 can output the information again to notify the user. In this case, information to be notified may be sound or vibration. By this configuration also, the electronic device 1 can notify again of presence of information that has already been notified to the user when there is a high possibility that the notified information has not been received by the user, thereby reducing the possibility that the user misses to know the information that has been notified.

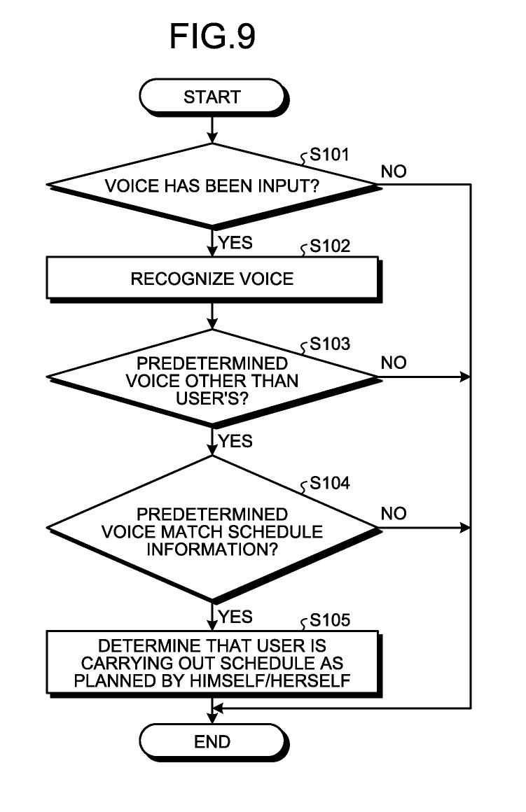

Control performed by the electronic device 1 is explained referring to FIG. 9 to FIG. 12. In the following, explanation is given, assuming that schedule information of a user is stored in the electronic device 1 before the control is performed.

FIG. 9 is a flowchart illustrating a first example of the control that is performed by the electronic device 1. The control of the electronic device 1 in FIG. 9 corresponds to a part of the operation of the electronic device 1 explained in FIGS. 5A and 5B.

Step S101: The controller 26 determines whether voice has been input. When voice has not been input (No at step S101), the controller 26 ends the processing. When voice has been input (Yes at step S101), the controller 26 proceeds to step S102.

Step S102: The controller 26 recognizes the input voice.

Step S103: The controller 26 determines whether the recognized voice is predetermined voice other than voice of a user. When determining that the recognized voice is not predetermined voice other than voice of the user (No at step S103), the controller 26 ends the processing. When determining that the recognized voice is the predetermined voice other than voice of the user (Yes at step S103), the controller 26 proceeds to step S104. The predetermined voice is, for example, announcement given in a train as described above.

Step S104: The controller 26 determines whether the recognized predetermined voice matches the schedule information of the user. When determining that the recognized predetermined voice and the schedule information of the user do not match (No at step S104), the controller 26 ends the processing. When determining that the recognized predetermined voice and the schedule information of the user match each other (Yes at step S105), the controller 26 proceeds to step S105.

Step S105: The controller 26 judges that the user is carrying out a schedule as planned in the schedule information of the user, and ends the processing.

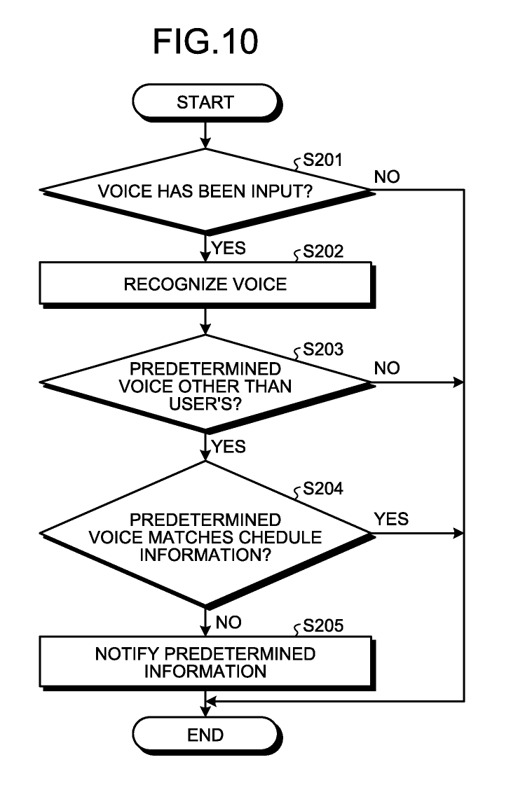

FIG. 10 is a flowchart illustrating a second example of the control that is performed by the electronic device 1. The control of the electronic device 1 in FIG. 10 corresponds to a part of the operation of the electronic device 1 explained in FIGS. 6A and 6B and the operation of the electronic device 1 in FIGS. 8A and 8B. The control in FIG. 10 can be performed only if the controller 26 determines that the user is carrying out a schedule as planned in the schedule information of the user (step S105) in the control illustrated in FIG. 9.

Step S201: The controller 26 determines whether voice has been input. When voice has not been input (No at step S201), the controller 26 ends the processing. When voice has been input (Yes at step S201), the controller 26 proceeds to step S202.

Step S202: The controller 26 recognizes the input voice.

Step S203: The controller 26 determines whether the recognized voice is predetermined voice other than that of the user. When determining that the recognized voice is not the predetermined voice other than that of the user (No at step S203), the controller 26 ends the processing. When determining that the recognized voice is the predetermined voice different from the voice described above and voice other than that of the user (Yes at step S203), the controller 26 proceeds to step S204. The predetermined voice is, for example, announcement given in a train as described above.

Step S204: The controller 26 determines whether the recognized predetermined voice and the schedule information of the user match each other. When determining that the recognized predetermined voice and the schedule information of the user match each other (Yes at step S205), the controller 26 ends the processing. When determining that the recognized predetermined voice and the schedule information of the user do not match (No at step S205), the controller 26 proceeds to step S205.

Step S205: The controller 26 notifies the user of predetermined information, and ends the processing. The notification of the predetermined information includes various kinds of notification, such as notification by displaying the information on the display 132, notification by vibration, and notification by voice output as described above.

In the control in FIG. 9 and FIG. 10, as described above, the controller 26 can accept an input of voice all the time, without setting a start timing and a stop timing of voice input acceptance. This enables to omit an operation of the user to make the electronic device 1 to start performing voice recognition, thereby improving the operability of the electronic device 1. In this case, the controller 26 can recognize predetermined environmental sound in the input voice, and thereby determine whether the user is on a predetermined means of transport based on the environmental sound, and can recognize input predetermined voice only when determining that the user is on the predetermined means of transport. The predetermined means of transport is, for example, a train, and the predetermined environmental sound is the noise of running train. The predetermined voice is announcement given in a train. Thus, not only omitting an operation of the user to make the electronic device 1 to start performing voice recognition, but also reduction of a possibility of misrecognition of input voice is possible.

As described above, the controller 26 can be configured to accept voice input only when determining that user is on a predetermined means of transport. The predetermined means of transport is, for example, a train, but is not limited thereto.

As described above, the controller 26 can be configured to accept voice input only when a predetermined application is operating. The predetermined application is, for example, an app that is provided in the electronic device 1 in advance to set whether to allow voice input and voice recognition of predetermined voice. When the predetermined application is the app to set whether to allow voice input and voice recognition of predetermined voice, the user can decide whether to have information notified on his/her own, and can reduce unnecessary information to be notified. Alternatively, the predetermined application is, for example, a music player app that can interfere with the user hearing predetermined voice. When the predetermined application is the music player app, the electronic device 1 can reduce a possibility of misrecognition of voice, while recognizing predetermined voice when there is a high possibility that the user cannot hear the predetermined voice.

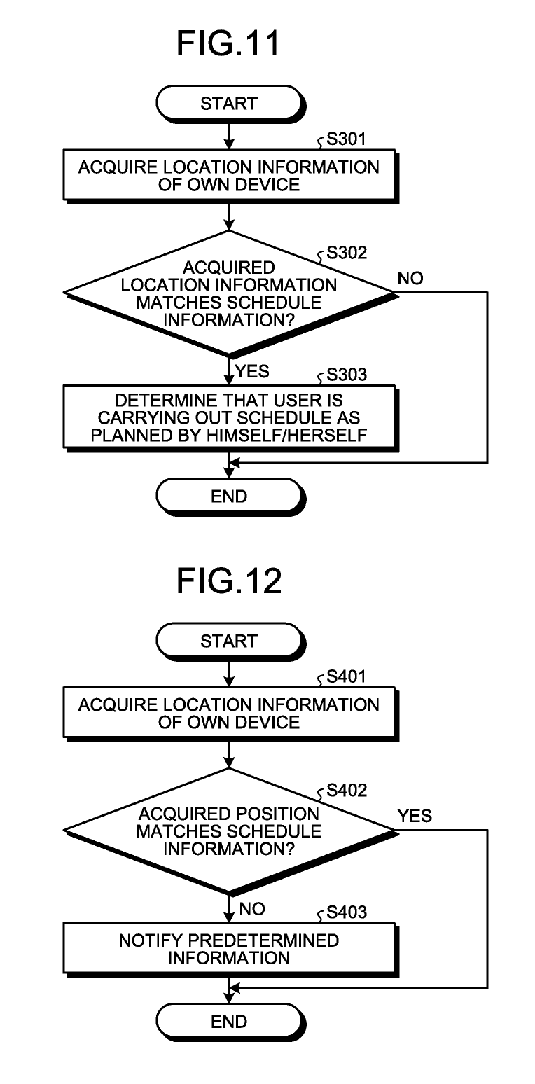

FIG. 11 is a flowchart illustrating a third example of control that is performed by the electronic device 1. The control of the electronic device 1 in FIG. 11 corresponds to a part of the operation of the electronic device 1 explained in FIGS. 5A and 5B.

Step S301: The location sensor 24 acquires location information that indicates its own current position.

Step S302: The controller 26 determines whether the schedule information of the user and the location information acquired by the location sensor 24 match each other. If determining that the schedule information of the user and the location information acquired by the location sensor 24 do not match (No at step S302), the controller 26 ends the processing. If determining that the schedule information of the user and the location information acquired by the location sensor 24 match with each other (Yes at step S302), the controller 26 proceeds to step S303. The schedule information of the user is, for example, location information of a planned get-off station of the user as described above.

Step S303: The controller 26 judges that the user is carrying out a schedule as planned in the schedule information of the user, and ends the processing.

The processing by the controller 26 of determining whether the schedule information of the user and the location information acquired by the location sensor 24 match each other at step S302 can be processing of determining whether the device itself has entered a predetermined range around location information of a location (for example, planned get-off station) at which the user is supposed to change a traveling means as the center from the outside of the predetermined range based on the location information acquired plural times by the location sensor 24. Thus, the electronic device 1 can accurately determine that the user is carrying out a schedule as planned in the schedule information of the user, resulting in improvement of the reliability of information to be notified.

FIG. 12 is a flowchart illustrating a fourth example of the control that is performed by the electronic device 1. The control of the electronic device 1 in FIG. 12 corresponds to a part of the operation of the electronic device 1 explained in FIGS. 7A and 7B. The control in FIG. 12 can be performed only if the controller 26 determines that a user is carrying out a schedule as planned in schedule information of the user (step S205) in the control explained in FIG. 10.

Step S401: The location sensor 24 acquires location information that indicates its own current position.

Step S402: The controller 26 determines whether the schedule information of the user and the location information acquired by the location sensor 24 match each other. If determining that the schedule information of the user and the location information acquired by the location sensor 24 match each other (Yes at step S402), the controller 26 ends the processing. If determining that the schedule information of the user and the location information acquired by the location sensor 24 do not match (No at step S402), the controller 26 proceeds to step S303. The schedule information of the user is, for example, route information from a starting station to a destination station for the user, as described above.

Step S403: The controller 26 notifies the user of predetermined information, and ends the processing. The notification of the predetermined information includes various kinds of notification, such as notification by displaying the information on the display 132, notification by vibration, and notification by voice output as described above.

The processing by the controller 26 of determining whether the schedule information of the user and the location information acquired by the location sensor 24 match each other at step S402 can be processing of determining whether the device itself has traveled toward a direction departing from the route information from the starting station to the destination station for the user based on the location information acquired plural times the location sensor 24. Thus, the electronic device 1 can accurately determine that the user is not carrying out a schedule as planned in the schedule information of the user, resulting in improvement of the reliability of information to be notified.

An electronic device having improved convenience in a technique of acquiring location information of the electronic device may be provided. An electronic device having improved convenience in a voice recognition technique may be provided as well.

Although the present disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic device comprising:
a voice input unit;
a location sensor that acquires location information indicating a current location of the device itself; and
a controller that can recognize voice input to the voice input unit, wherein
if the controller determines that a user is not carrying out a schedule as planned in schedule information of the user stored in advance based on the schedule information, and at least one of the location information and recognized predetermined voice other than voice of the user, the controller notifies the user of predetermined information.

2. The electronic device according to claim 1, wherein
the controller determines that the user is carrying out a schedule as planned in first schedule information based on the first schedule information, and at least one of first location information and recognized first predetermined voice other than the voice of the user,
the controller notifies the user of the predetermined information if the controller determines that the user is not carrying out a schedule as planned in second schedule information based on the second schedule information, and at least one of second location information and recognized second predetermined voice other than the voice of the user after determining that the user is carrying out the schedule as planned in the first schedule information, and
the controller does not notify the user of the predetermined information even if the controller determines that the user is not carrying out the schedule as planned in the second schedule information based on the second schedule information, and at least one of the second location information and the recognized second predetermined voice if the controller has not determined that the user is carrying out the schedule as planned in the first schedule information.

3. The electronic device according to claim 2, wherein
the controller determines that the user has arrived at a planned get-off station of a train that the user is on based on the first schedule information, and at least one of the first location information and the recognized first predetermined voice,
the controller notifies the user of the predetermined information if determining that the user has failed to get off the train based on the second schedule information, and at least one of the second location information and the recognized second predetermined voice after determining that the user has arrived at the planned get-off station, and
the controller does not notify the user of the predetermined information even if determining that the user has failed to get off the train based on the second schedule information, and at least one of the second location information and the recognized second predetermined voice, if the controller has not determined that the user has arrived at the planned get-off station.

4. The electronic device according to claim 3, wherein
the controller determines that the user has arrived at the planned get-off station based on the first schedule information and the recognized first predetermined voice, and
the controller determines that the user has failed to get off the train based on the second schedule information and the recognized second predetermined voice.

5. The electronic device according to claim 4, wherein
the recognized first predetermined voice includes a name of the planned get-off station, and
the recognized second predetermined voice does not include a name of the planned get-off station.

6. The electronic device according to claim 5, wherein
the recognized second predetermined voice includes a name of a station that is present on a line of the train, and present ahead of the planned get-off station for the user in a traveling direction of the train.

7. The electronic device according to claim 5, wherein
the controller determines that the user has arrived at a planned get-off station if determining that the first schedule information matches the recognized first predetermined voice, and
the controller determines that the user has failed to get off the train if determining that the second schedule information doesn't match the recognized second predetermined voice.

8. The electronic device according to claim 3, wherein
the controller determines that the user has arrived at the planned get-off station based on the first schedule information and the first location information, and
the controller determines that the user has failed to get off the train based on the second schedule information and the second location information.

9. The electronic device according to claim 8, wherein
the first schedule information includes location information corresponding to a name of the planned get-off station, and
the second schedule information includes route information from a starting station to a destination station for the user.

10. The electronic device according to claim 9, wherein
the controller determines that the user has arrived at the planned get-off station if determining that the device itself has entered a predetermined range around the location information corresponding to the planned get-off station as a center from outside of the predetermined range based on the first location information.

11. The electronic device according to claim 9, wherein
the controller determines that the user has failed to get off the train if determining that the device itself is moving toward a direction departing from the route information based on the second location information.

12. The electronic device according to claim 11, wherein
the direction departing from the route information is a traveling direction of the train.

13. The electronic device according to claim 1, wherein
the schedule information includes arrival time information of stop stations of the train, and
the controller notifies the user of the predetermined information if the controller determines that the user is not carrying out the schedule as planned in the schedule information based on the schedule information, a current time, and at least one of the location information and the recognized predetermined voice.

14. The electronic device according to claim 1, further comprising
a detector that detects its own movement, wherein
the controller determines that the device itself has not moved for predetermined time based on a detection result by the detector, and
the controller notifies the user of the predetermined information if the controller determines that the user is not carrying out the schedule as planned in the schedule information based on at least one of the location information and the recognized predetermined voice, and on a determination result indicating that the device has not moved for the predetermined time.

15. The electronic device according to claim 1, wherein
the controller searches a route information to the destination station of the user based on the location information, and
the controller notifies the user of the route information as the predetermined information.

16. The electronic device according to claim 4, wherein
the controller searches a route information to the destination station of the user based on the second predetermined voice, and
the controller notifies the user of the route information as the predetermined information.

17. The electronic device according to claim 15, further comprising
a voice output interface to which an external speaker can be connected, wherein
the controller causes the voice output interface to output the route information.

18. A control method for an electronic device that includes a voice input unit, a location sensor that acquires location information indicating a current location of the device itself, and a controller that can recognize voice input to the voice input unit, the method comprising:
determining whether a user is carrying out a schedule as planned in schedule information of the user stored in advance based on the schedule information, and at least one of the location information and recognized predetermined voice other than voice of the user; and
notifying the user of predetermined information if it is determined that the user is not carrying out the schedule as planned in the schedule information.

19. A non-transitory computer readable recording medium storing therein a control program for an electronic device that includes a voice input unit, a location sensor that acquires location information indicating a current location of the device itself, and a controller that can recognize voice input to the voice input unit, the control program making the electronic device execute:
determining whether a user is carrying out a schedule as planned in schedule information of the user stored in advance based on the schedule information, and at least one of the location information and recognized predetermined voice other than voice of the user; and
notifying the user of predetermined information if it is determined that the user is not carrying out the schedule as planned in the schedule information.
